(19) United States
(12) Patent Application Publication
(10) Pub. No.: US 2019/0360200 A1
(43) Pub. Date: Nov. 28, 2019

(54) Adjustable Architectural Frame System

(71) Applicant: Glenn Sloss, CLINTON, CT (US)

(72) Inventor: Glenn Sloss, CLINTON, CT (US)

(21) Appl. No.: 16/534,860

(22) Filed: Aug. 7, 2019

Related U.S. Application Data
(63) Continuation-in-part of application No. PCT/IB2017/054895, filed on Aug. 10, 2017.
(60) Provisional application No. 62/765,590, filed on Aug. 31, 2018.
(60) Provisional application No. 62/736,327, filed on Sep. 25, 2018.
(60) Provisional application No. 62/766,832, filed on Nov. 6, 2018.

(51) Int. Cl. E04B 2/74; E06B 9/08; E06B 3/48; E06B 3/36; E05C 19/00; E06B 1/70; E05D 15/26; E06B 1/52

(52) U.S. Cl. CPC E04B 2/7459; E04B 2/7435; E06B 9/08; E06B 3/481; E06B 3/36; E05C 19/003; E05Y 2900/132; E06B 1/70; E05D 15/264; E06B 1/52; E04B 2002/7479; E05Y 2900/142; E04B 2/7455

(57) ABSTRACT

An adjustable architectural frame uses multiple length-adjustable support beams and a pair of panel-connecting mechanisms to function as a framework for mounting architectural panels of varying size and construction. The support beams of the adjustable architectural panel include width-adjustment beams and height adjustment beams. The width-adjustment beams and the height-adjustment beams are preferably telescopic beams that have lengths which can be increased or decreased. These beams are terminally connected to create a quadrilateral frame that has physical dimensions which can be modified as a user desires. Additionally, the adjustable architectural panel makes use of the pair of panel-connecting mechanisms to mount various types of architectural panels onto the adjustable architectural frame. For example, the pair of panel-connecting mechanisms can be tracks along which an accordion door runs. Alternatively, the pair of panel-connecting mechanisms can be rods which support a sheet of material that is played out from a reel.

The current application is a continuation-in-part (CIP) application of the Patent Cooperation Treaty (PCT) application PCT/IB2017/054895 filed on Aug. 10, 2017.

The current application claims a priority to the U.S. Provisional Patent application Ser. No. 62/765,590 filed on Aug. 31, 2018, a priority to the U.S. Provisional Patent application Ser. No. 62/736,327 filed on Sep. 25, 2018, and a priority to the U.S. Provisional Patent application Ser. No. 62/766,832 filed on Nov. 6, 2018.

### FIELD OF THE INVENTION

The present invention relates generally to an architectural frame. More specifically, the present invention relates to an architectural frame that employs a universal panel connection system and adjustable length support beams to enable a user to modify the frame's length and width to accommodate architectural panels of varying shape and design.

### BACKGROUND OF THE INVENTION

There are many situations where an architectural panel is used to form a partition between the sections of a room. These architectural panels enable a user to effectively utilize the space to perform various functions. While these architectural panels are generally collapsible, they are often designed to work with a single type of frame or track system. This limitation prevents the use of the architectural panel system as a partition or structural support for a wide range of applications. Moreover, the frame or track that is designed to support the architectural panel is generally a dedicated system with dimensions that cannot be modified once installed.

The present invention addresses this issue by making use of an architectural panel with physical dimensions that can be modified as the user desires. Furthermore, the present invention makes use of a universal panel-connection system that enables the user to mount various types of architectural panels onto the adjustable frame formed by the present invention. The combination of these functionalities generates an architectural panel that can be used to satisfy a wide range of building requirements.

### BRIEF DESCRIPTION OF THE DRAWINGS

FIG. 1 is a perspective view of the present invention.

FIG. 2 is a perspective view of the first alternative embodiment of the present invention.

FIG. 3 is a perspective view of the second alternative embodiment of the present invention.

FIG. 4 is a front view of the second alternative embodiment of the present invention.

FIG. 5 is a rear view of the second alternative embodiment of the present invention; this view shows the length-adjustable security bar maintaining the accordion door in the extended configuration.

FIG. 6 is a bottom perspective view of the second alternative embodiment of the present invention; the accordion door is removed in this figure.

FIG. 7 is a perspective view of the third alternative embodiment of the present invention.

FIG. 8 is a detailed view of the second angle-adjustment joint used in the present invention taken along line 8-8 in FIG. 7.

FIG. 9 is a detailed view of the first angle-adjustment joint used in the present invention taken along line 9-9 in FIG. 7.

FIG. 10 is a detailed view of the handle and handle-receiving slot used in the present invention taken along line 10-10 in FIG. 7.

FIG. 11 is a perspective view of the adjustable ceiling-connection frame used in the present invention.

FIG. 12 is an exploded front view of the present invention.

FIG. 13 is a perspective view of the length-adjustable valance used in the present invention.

FIG. 14 is a perspective view of the length-adjustable threshold used in the present invention.

FIG. 15 is a front perspective view of another embodiment of the present invention displaying the first cable, the first pulley, the second cable, and the second pulley.

FIG. 16 is a left-side view of another embodiment of the present invention displaying the first fastener and the second fastener.

FIG. 17 is a front perspective view of another embodiment of the present invention displaying the at least one first guide bracket and the at least one second guide bracket.

FIG. 18 is a left-side view of another embodiment of the present invention displaying the at least one first guide bracket and the at least one second guide bracket.

FIG. 19 is a cross-sectional view taken along section 19-19 from FIG. 18.

FIG. 20 is a front perspective view of another embodiment of the present invention displaying the first door, the second door, and the third door of the accordion door.

FIG. 21 is a top perspective view of another embodiment of the present invention displaying the roller assembly.

FIG. 22 is a bottom perspective view of another embodiment of the present invention displaying the latched slide pin.

FIG. 23 is a front view of another embodiment of the present invention displaying the roller assembly.

FIG. 24 is a cross-sectional view taken along section 24-24 from FIG. 23.

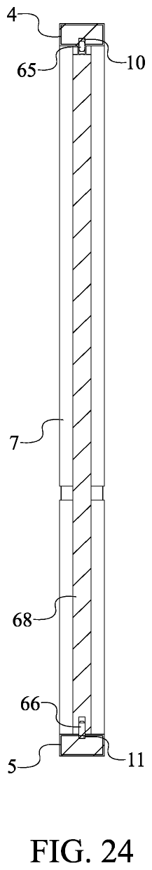

FIG. 25 is a front perspective of another embodiment of the present invention displaying the roller assembly and the latched slide pin.

### DETAIL DESCRIPTIONS OF THE INVENTION

All illustrations of the drawings are for the purpose of describing selected versions of the present invention and are not intended to limit the scope of the present invention.

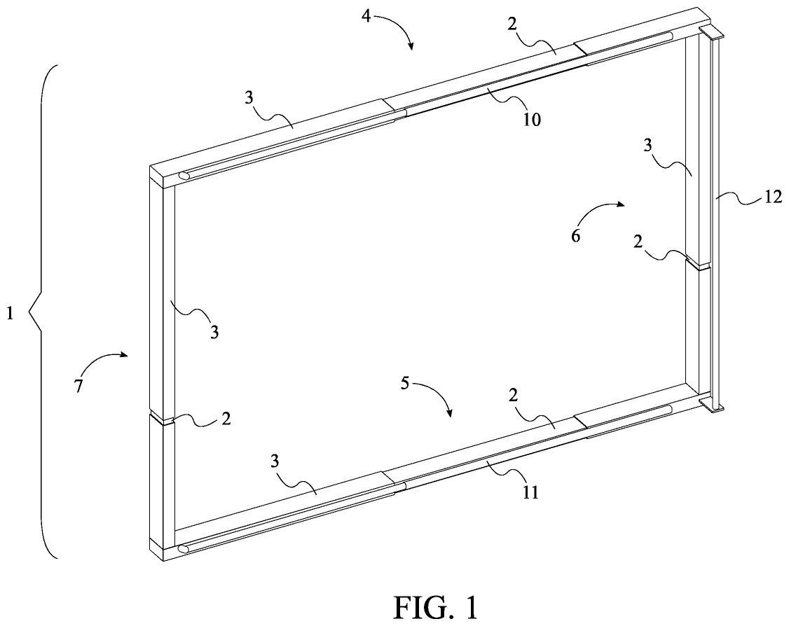

As can be seen in FIG. 1 through FIG. 14, the present invention, the adjustable architectural frame system, is a reconfigurable framework with physical dimensions that can be adapted to support architectural panels of varying shape and size. To accomplish this, the present invention is composed of beams whose length can be modified, and a universal panel mounting system. The length of the beams can be adjusted to form a frame capable of accommodating the physical dimensions of various user-selected architectural panel systems. The present invention is designed to be used in a wide range of applications. For example, the present invention can be used to form a partition between the section of a room, or the retractable walls of an awning-roofed room, or the covering of a pool. In addition to constructing permanent partitions, the length-adjustable nature of the present invention enables a user to construct collapsible partition systems that can be deployed at will.

As can be seen in FIG. 1, to achieve the above-described functionality, the present invention comprises a plurality of length-adjustable support beams 1, a first panel-connecting mechanism 10 and a second panel-connecting mechanism 11. Each of the plurality of length-adjustable support beams 1 is a rod that can be extended or retracted as the user desires. Consequently, the user is able to modify the physical dimensions of the adjustable frame formed by the present invention. Specifically, the plurality of length-adjustable support beams 1 comprises a first width-adjustment beam 4, a second width-adjustment beam 5, a first height-adjustment beam 6, and a second height-adjustment beam 7. To form an adjustable frame, the first height-adjustment beam 6 is terminally connected to the first width-adjustment beam 4. Additionally, the second height-adjustment beam 7 is terminally connected to the first width-adjustment beam 4, opposite to the first height-adjustment beam 6. Furthermore, the second width-adjustment beam 5 is terminally connected to the first height-adjustment beam 6, opposite to the second height-adjustment beam 7. Finally, the second height-adjustment beam 7 is terminally connected to the second width-adjustment beam 5, opposite to the first height-adjustment beam 6. Thus positioned, the first width-adjustment beam 4, the second width-adjustment beam 5, the first height-adjustment beam 6, and the second height-adjustment beam 7 form a quadrilateral frame. Because of the length-adjustable nature of the plurality of length-adjustable support beams 1, the length and width of the quadrilateral frame formed by the first width-adjustment beam 4, the second width-adjustment beam 5, the first height-adjustment beam 6, and the second height-adjustment beam 7 can be adjusted as the user desires.

As can be seen in FIG. 1, the first panel-connecting mechanism 10 and the second panel-connecting mechanism 11 act as a universal panel mounting system that enables the user to attach architectural panels of varying shape and design to the adjustable frame formed by the plurality of length-adjustable support beams 1. To accomplish this, the first panel-connecting mechanism 10 is laterally mounted along the first width-adjustment beam 4. Similarly, the second panel-connecting mechanism 11 is laterally mounted along the second width-adjustment beam 5. Consequently, the user is able to mount an architectural panel system within the adjustable frame formed by the plurality of length-adjustable support beams 1. Specifically, first panel-connection mechanism and the second panel-connection mechanism are used to suspend the attached architectural panel system between the first width-adjustment beam 4 and the second width-adjustment beam 5.

As can be seen in FIG. 1, the present invention makes use of a telescoping construction to enable the plurality of length-adjustable support beams 1 to be extended or retracted as the user desires. As such, each of the plurality of length-adjustable support beams 1 is a multicomponent member that comprises an interior rail 2 and an exterior sleeve 3. The exterior sleeve 3 is a rigid tube that acts as one half of each of the length-adjustable support beams 1. Alternatively, the interior rail 2 is a rigid bar that acts as the second half of each of the length-adjustable support beams. Using this construction, the exterior sleeve 3 is telescopically engaged along the interior rail 2. As a result, the exterior sleeve 3 is able to slide along the interior rail 2 when the user modifies the length of a single length-adjustable support beam 1.

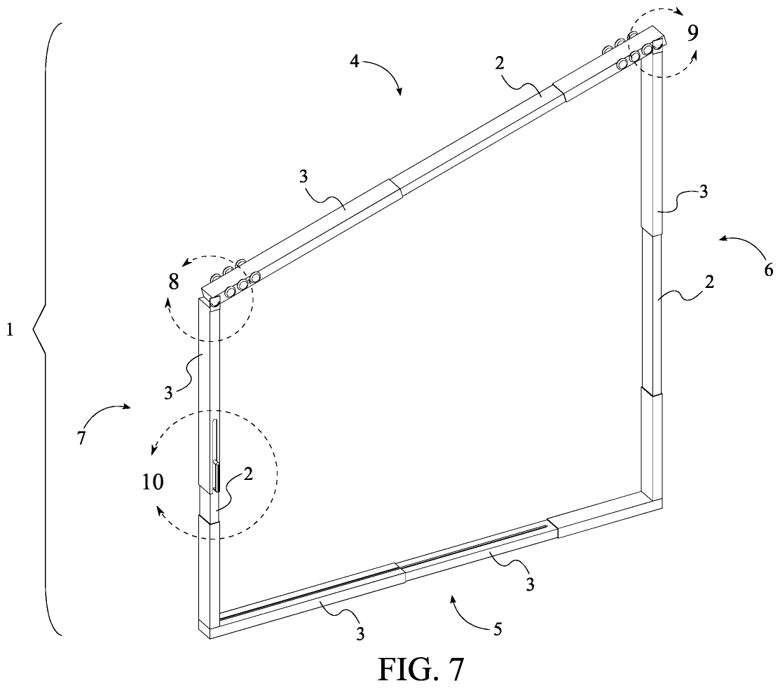

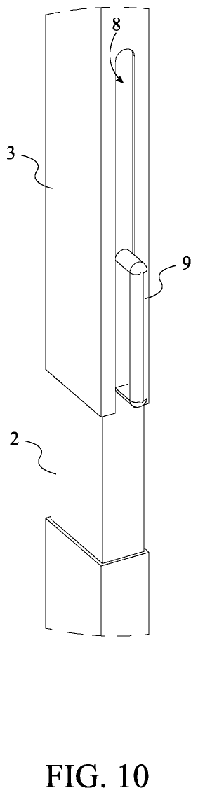

As can be seen in FIG. 7 and FIG. 10, the present invention is further equipped with a handle 9 that facilitates modifying the width of the adjustable frame that is formed by the plurality of length-adjustable support beams 1. The handle 9 is designed to remain a constant distance from the floor on which the present invention is resting. To accomplish this, the second height-adjustment beam 7 comprises a handle 9 and a handle-receiving slot 8. The handle 9 is ergonomically designed to be easily grasped by the user's hand. The handle-receiving slot 8 traverses into the exterior sleeve 3. Additionally, the handle-receiving slot 8 is positioned along the exterior sleeve 3. Thus positioned, the handle-receiving slot 8 enables the exterior sleeve 3 of the second-height-adjustment beam to slide along the interior rail 2 of the second height-adjustment beam 7 without coming into contact with the handle. As has been previously alluded to, but never explicitly described, the handle 9 is laterally connected to the interior rail 2. Furthermore, the handle 9 is slidably engaged along the handle-receiving slot 8. Accordingly, the handle 9 is connected to the interior rail 2 which remains fixed while the exterior sleeve 3 is repositioned when the user modifies the overall length of the second height-adjustment beam 7. Moreover, the handle 9 is positioned within the handle-receiving slot 8 so that the handle 9 does not impede the sliding motion of the exterior sleeve 3 over the interior rail 2.

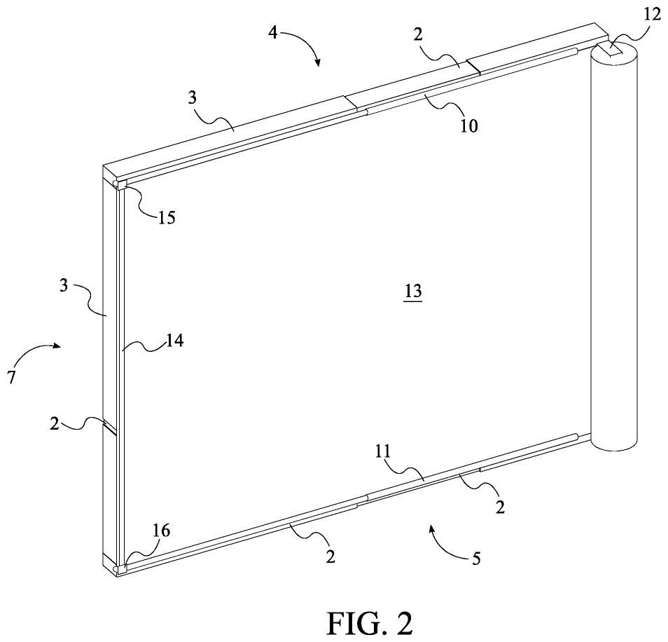

As can be seen in FIG. 1 and FIG. 2, a first alternative embodiment of the present invention makes use of a reel of material to form a reconfigurable panel. In this embodiment, the user plays out material from the reel to form a panel that stretches across the space between the first height-adjustment beam 6 and the second height-adjustment beam 7. In this embodiment, the first panel-connecting mechanism 10 is a first telescopic guide rail 10, and the second panel-connecting mechanism 11 is a second telescopic guide rail 11. To implement the reel system, the present invention comprises a panel reel 12, a sheet of panel material 13 and a panel extension rod 14. The first telescopic guide rail 10 and the second telescopic guide rail 11 are length adjustable rails that are used to mount the panel reel system onto the plurality of length-adjustable support beams 1. Specifically, the first telescopic guide rod is mounted along the first width-adjustment beam 4. Similarly, the second telescopic guide rod is mounted along the second width-adjustment beam 5. Thus positioned, the first telescopic guide rail 10 and the second telescopic guide rail 11 form tracks along which the reel system runs. The sheet of panel material 13 is a flexible sheet that functions as a panel when stretched between the first height-adjustment beam 6 and the second height-adjustment beam 7. The panel reel 12 is a reel mechanism that is used to house and play out the sheet of panel material 13. To accomplish this, the panel reel 12 is mounted along the first height-adjustment beam 6. Additionally, the sheet of panel material 13 is wound about the panel reel 12. As a result, the panel reel 12 maintains the sheet of panel material 13 in a position that facilitates being stretched between the first height-adjustment beam 6 and the second height-adjustment beam 7.

As can be seen in FIG. 1 and FIG. 2, the panel extension rod 14 is a rigid rod used. Additionally, the panel extension rod 14 is slidably mounted in between the first telescopic guide rod and the second telescopic guide rod so that the panel extension rod 14 is able to slide along the lengths of the first telescopic guide rail 10 and the second telescopic guide rail 11. The panel extension rod 14 is adjacently connected to the sheet of panel material 13, opposite to the panel reel 12. Consequently, moving the panel extension rod 14 along the first telescopic guide rod and the second telescopic guide rod causes the sheet of panel material 13 to be played out of the panel reel 12. For example, if the present invention is being used as a partition between sections of a room, then the user can extend the first width-adjustment beam 4 and the second width-adjustment beam 5 to a desired length. The user will then pull the panel extension rod 14 along the first telescopic guide rod and the second telescopic guide rod and toward the second height-adjustment beam 7. As the user pulls the panel extension rod 14 toward the second height-adjustment beam 7, the sheet of panel material 13 will be played out of the panel reel 12 and stretched over the space between the first height-adjustment member and the second height adjustment member.

As can be seen in FIG. 1 and FIG. 2, the first alternative embodiment of the present invention is designed to enable the user to easily pull the sheet of panel material 13 across the space between the first height-adjustment. As such, the first alternative embodiment of the present invention further comprises a first rod carriage 15, a second rod carriage 16, and a carriage-actuation mechanism 17. The first rod carriage 15 is a mounting device that is designed to slide along the first telescopic guide rod. Additionally, the first rod carriage 15 is terminally connected to the panel extension rod 14 so that displacement of the first rod carriage 15 is transferred to the panel extension rod 14. Moreover, the first rod carriage 15 is slidably engaged along the first telescopic guide rod. Accordingly, the first rod carriage 15 is able to slide along the length of the first telescopic guide rod. Similarly, the second rod carriage 16 is a mounting device that is designed to slide along the second telescopic guide rod. Additionally, the second rod carriage 16 is terminally connected to the panel extension rod 14 so that displacement of the second rod carriage 16 is transferred to the panel extension rod 14. Moreover, the second rod carriage 16 is slidably engaged along the second telescopic guide rod. Accordingly, the second rod carriage 16 is able to slide along the length of the second telescopic guide rod. The carriage-actuation mechanism 17 is a type of linear actuator that can be, but is not limited to being, a hydraulic press, a motor, a worm gear system, or a constant force spring assembly. The carriage-actuation mechanism 17 is operatively integrated in between the first rod carriage 15 and the first height-adjustment beam 6, wherein the carriage-actuation mechanism 17 is used to slide the first rod carriage 15 along the first telescoping guide rail. This integration facilitates positioning the panel extension rod 14 ad a desired location along the first telescopic guide rod.

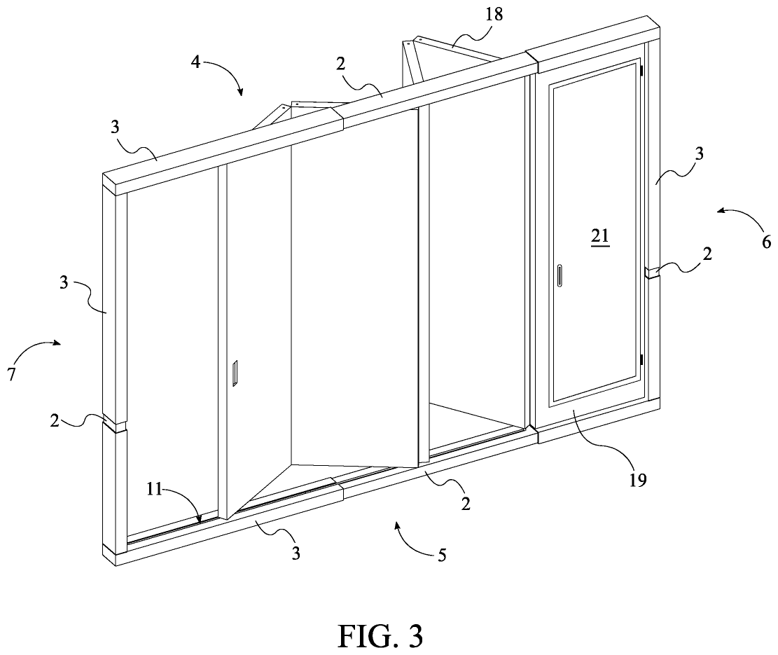

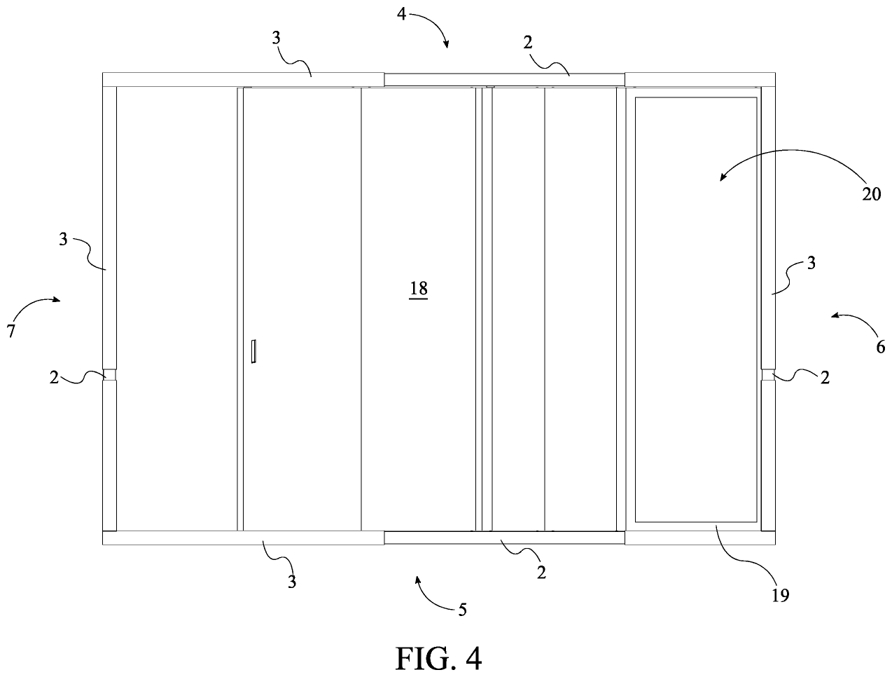

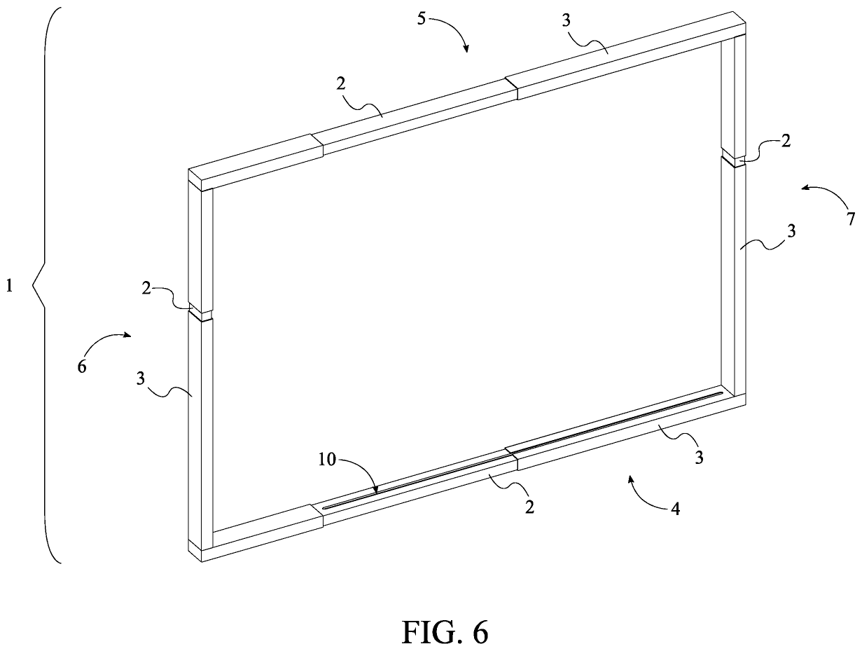

As can be seen in FIG. 3, FIG. 4, and FIG. 6, a second alternative embodiment of the present invention makes use of an accordion door system to form a reconfigurable panel. In this embodiment, the user extends the folding panels of an accordion door system to form a panel that stretches across the space between the first height-adjustment beam 6 and the second height-adjustment beam 7. In this embodiment, the first panel-connecting mechanism 10 is a first track 10, and the second panel-connecting mechanism 11 is a second frack. To implement the accordion door system, the present invention comprises an accordion door 18. The accordion door 18 is a multipaneled assembly where each of the panels are serially distributed and hingedly connected. The first track 10 and the second track 11 are raceways that mount the accordion door 18 in between the first width-adjustment beam 4 and the second width-adjustment beam 5. As such, the first track 10 is connected along the first width-adjustment beam 4. Similarly, the second track 11 is connected along the first width-adjustment beam 4. Thus positioned, the first track 10 and the second track 11 maintain the accordion door 18 in a desired position within the frame formed by the plurality of length-adjustable support beams 1. Expounding on the descriptions of the arrangement of the accordion door 18, a first side of the accordion door 18 is mounted adjacent to the first height-adjustment beam 6. As a result, one side of the accordion door 18 remains fixed in place while the opposite side of the accordion door 18 is able to be repositioned as the user desires. Additionally, the accordion door 18 is slidably mounted in between the first track 10 and the second track 11. Consequently, the accordion door 18 is able to slide along the first track 10 and the second track 11 when being extended or collapsed by the user. Specifically, the serially distributed and hingedly connected panels of the accordion door 18 form a sufficiently flat panel when extended along the first track 10 and the second track 11. To achieve this, the user pulls a second side of the accordion door 18 away from the first height-adjustment panel into an extended configuration. Conversely, the serially distributed and hingedly connected panels of the accordion door 18 are transitioned into a collapsed zig-zag configuration when the second side of the accordion door 18 is pushed toward the first-height adjustment beam.

As can be seen in FIG. 3, FIG. 4, and FIG. 6, in addition to functioning as a collapsible panel system the accordion door 18 is designed with an integrated doorway that enables the user to pass through the accordion door 18 without collapsing the accordion door 18. To accomplish this, the accordion door 18 comprises an openable panel 19, an entryway hole 20, and a nested door 21. The openable panel 19 is one of the multiple serially distributed and hingedly connected panels that form the accordion door 18. Specifically, the openable panel 19 is the panel that is positioned closest to the first height-adjustment beam 6. The entryway hole 20 traverses through the openable panel 19 so that the user is able to pass through the openable panel 19 while the accordion is in the extended configuration. To maintain the accordion door's 18 ability to function as a partition, the nested door 21 is hingedly connected to the openable panel 19 across the entryway hole 20. The nested door 21 is a slab of material that acts as a door to cover the entryway hole 20. In a first supplementary embodiment of the accordion door system, the accordion door 18 is a sheet of material that is constructed to fold in on itself when moved into the collapsed configuration. To accomplish this, a top plurality of holes is cut along a top edge of the sheet of material and a plurality of bottom holes is cut along a bottom edge of the sheet of material. Furthermore, a first cable is threaded through the plurality of top holes and a second cable is threaded through the plurality of bottom holes so that retracting the first cable and the second cable toward the first height-adjustment beam 6 moves the sheet of material into the collapsed configuration. The sheet of material is mounted in between the first panel-connecting mechanism 10 and the second panel-connecting mechanism 11 so that the sheet of material runs along the length of the first width-adjustment beam 4 and the second width-adjustment beam 5. As the first cable and the second cable are pulled toward the first height-adjustment beam 6 the sheet of material is forced to become a series of pleated folds. To accomplish this the first cable and the second cable are each terminally connected to a corresponding motor. The corresponding motor is mounted onto the first height-adjustment beam 6. Additionally, the first cable and the second cable are each terminally connected to the sheet of material, opposite to the corresponding motor. When the corresponding motor is activated the first cable and the second cable are retracted toward the first height-adjustment beam 6; thus, moving the sheet of material into the collapsed configuration.

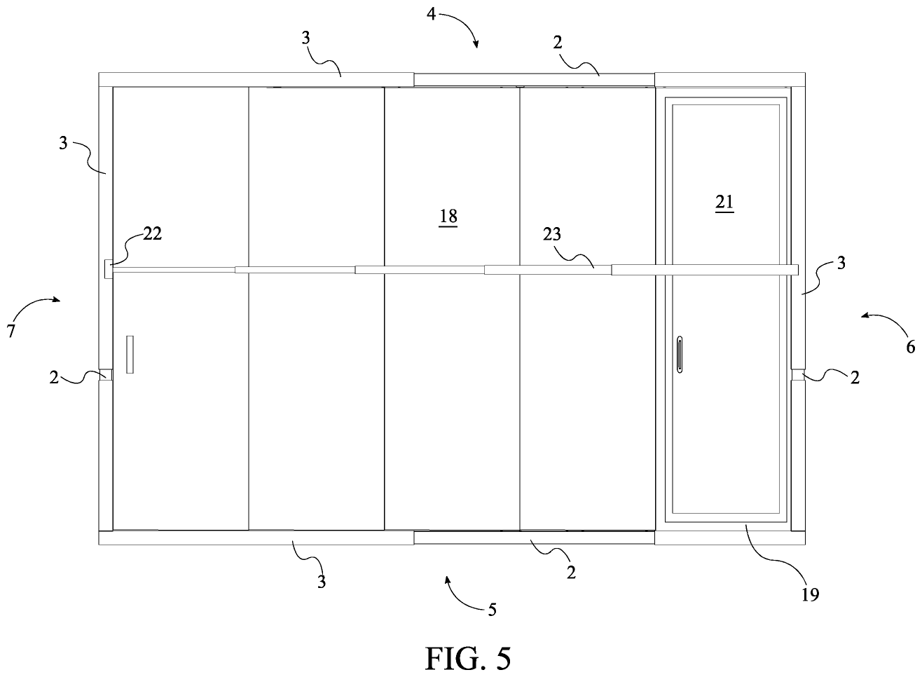

As can be seen in FIG. 4 and FIG. 5, the second alternative embodiment of the present invention is designed with an added security feature that prevents the accordion door 18 from being moved into the collapsed configuration while engaged. To accomplish this, the second alternative embodiment of the present invention comprises a bar-receiving receptacle 22 and a length-adjustable bar. The bar-receiving receptacle 22 is a disengage able locking mechanism that clamps around one end of the length-adjustable security bar 23. Additionally, the bar-receiving receptacle 22 is adjacently connected to the second height-adjustment beam 7 so that the adjustable length security bar will be held across the accordion door 18. Thus, preventing the accordion door 18 from being moved into the collapsed configuration. The length-adjustable security bar 23 is preferably a telescopic beam. A first end of the length-adjustable security bar 23 is adjacently and pivotably connected to the first height-adjustment beam 6 so that the length-adjustable security bar 23 can be transitioned between a locked position and an unlocked position by pivoting the length-adjustable security bar 23 about the pivotal connection with the first length-adjustment beam. Conversely, a second end of the length-adjustable security bar 23 engages into the bar-receiving receptacle 22. As a result, the length-adjustable security bar 23 is retained in the locked configuration while engaged into the bar-receiving receptacle 22. Finally, the length-adjustable security bar 23 being positioned across the accordion door 18 so that the accordion door 18 is prevented from being moved into the collapsed configuration.

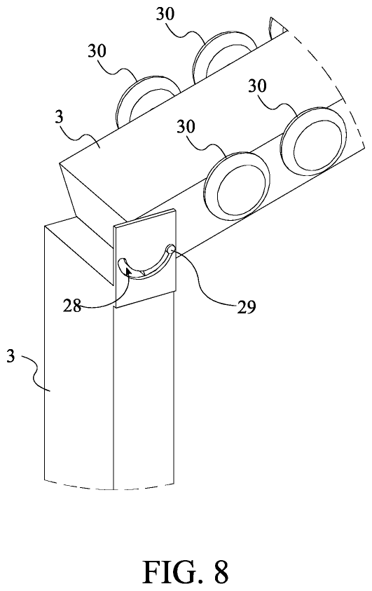

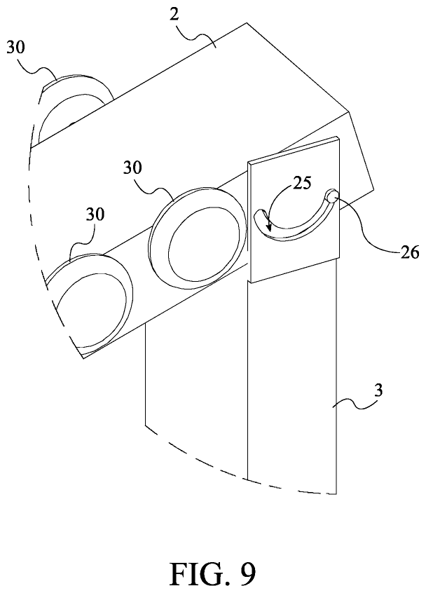

As can be seen in FIG. 7, FIG. 8, and FIG. 9, a third alternative embodiment of the present invention makes use of an adjustable joint system to connect the first width-adjustment beam 4 to the first height-adjustment beam 6 and the second height-adjustment beam 7. In this embodiment, the user is able to form quadrilateral frames that are not rectangles. To implement the adjustable joint system, the third embodiment of the present invention comprises a first angle-adjustment joint 24 and a second angle-adjustment joint 27. The first angle-adjustment joint 24 and the second angle-adjustment joint 27 are joints that enable the user to adjust the length of the first height-adjustment beam 6 and the length of the second height-adjustment beam 7 independently. To accomplish this, the first angle-adjustment joint 24 is integrated into the terminal connection between the first height-adjustment beam 6 and the first width-adjustment beam 4. As a result, the first width-adjustment beam 4 is able to pivot about the terminal connection with the first height-adjustment beam 6. This enables the angle between the first width-adjustment beam 4 and the first height-adjustment beam 6 to be modified by increasing or decreasing the length of the first height-adjustment beam 6 with respect to the length of the second height-adjustment beam 7. Similarly, the second angle-adjustment joint 27 is integrated into the terminal connection between the second height-adjustment beam 7 and the first width-adjustment beam 4. Accordingly, the angle between the first width-adjustment beam 4 and the second height-adjustment beam 7 to be modified by increasing or decreasing the length of the second height-adjustment beam 7 with respect to the length of the first height-adjustment beam 6.

As can be seen in FIG. 7 and FIG. 9, in the third alternative embodiment of the present invention, the first angle-adjustment joint 24 comprises a first semicircular groove 25 and a first connector peg 26. These components enable the first angle-adjustment joint 24 to transition between various angles without becoming jammed. To accomplish this, the first semicircular groove 25 traverses into the first height-adjustment beam 6. Additionally, first connector peg 26 is laterally connected to the first width-adjustment beam 4. Moreover, the first connector peg 26 is engaged along the first semicircular groove 25. Accordingly, the first connector peg 26 is able to slide along the first semicircular groove 25 while the angle between the first width-adjustment beam 4 and the first height-adjustment beam 6 is modified.

As can be seen in FIG. 7 and FIG. 8, in the third alternative embodiment of the present invention, the second angle-adjustment joint 27 comprises a second semicircular groove 28 and a second connector peg 29. These components enable the second angle-adjustment joint 27 to transition between various angles without becoming jammed. To accomplish this, the second semicircular groove 28 traverses into the second height-adjustment beam 7. Additionally, second connector peg 29 is laterally connected to the first width-adjustment beam 4. Moreover, the second connector peg 29 is engaged along the second semicircular groove 28. Accordingly, the second connector peg 29 is able to slide along the second semicircular groove 28 while the angle between the first width-adjustment beam 4 and the second height-adjustment beam lis modified. The third alternative embodiment of the present invention is preferably used to form the walls of a retractable awning system. As such the adjustable frame formed by the plurality of length-adjustable support beams 1 is able to form a quadrilateral-shaped frame where the first width-adjustment beam 4 is oriented at an angle that mirrors the angle of the retractable awning system to which the present invention is attached. Additionally, the third alternative embodiment makes use of a rolling system that enables the adjustable frame formed by the plurality of length-adjustable support beams 1 to move along the length of the retractable awning system while the retractable awning system is extended. To accomplish this, the third alternative embodiment of the present invention comprises a plurality of roller wheels 30. Specifically, each of the plurality of roller wheels 30 is laterally mounted onto the first width-adjustment beam 4. Furthermore, the plurality of roller wheels 30 is distributed along the first width-adjustment beam 4. Thus positioned, the plurality of roller wheels 30 facilitates sliding the first width-adjustment beam 4 along the length of the retractable awning system as the adjustable frame formed by the plurality of length-adjustment beams is moved between the extended configuration and the collapsed configuration.

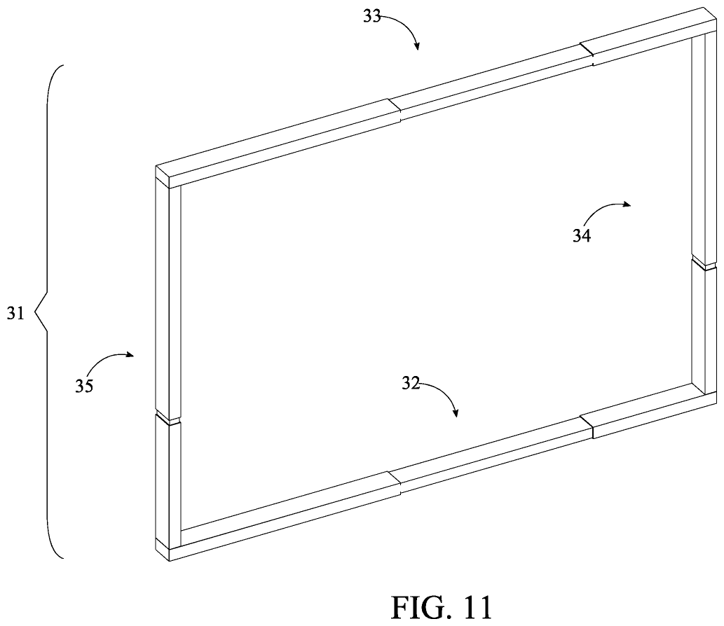

As can be seen in FIG. 1 and FIG. 11, as described above, the present invention can be used to form a collapsible partition with various types of paneling systems. Yet, the present invention is designed to be integrated into various types of building structures. To that end, the present invention comprises an adjustable ceiling-connection frame 31 that is a secondary adjustable frame with height and width dimensions that can be modified to satisfy the user's space requirements. The adjustable ceiling-connection frame 31 is mounted onto the first height-adjustment beam 6 and the second height-adjustment beam 7. As a result, the adjustable ceiling-connection frame 31 is able to permanently connect the adjustable frame formed by the plurality of length-adjustable support beams 1 to the ceiling of a room.

As can be seen in FIG. 1 and FIG. 11, the adjustable ceiling-connection frame 31 is designed to mimic the width-adjustable and height-adjustable characteristics of the adjustable frame formed by the plurality of length-adjustable support beams 1. To accomplish this, the adjustable ceiling-connection frame 31 comprises a first width-adjustment shaft 32, a second width-adjustment shaft 33, a first height-adjustment shaft 34, and a second height-adjustment shaft 34. The first width-adjustment shaft 32, the second width-adjustment shaft 33, the first height-adjustment shaft 34, and the second height-adjustment shaft 34 are preferably telescopic members that mirror the construction of the plurality of length-adjustable support beams 1. To form a secondary adjustable frame, the first height-adjustment shaft 34 is terminally connected to the first width-adjustment shaft 32. Additionally, the second height-adjustment shaft 34 is terminally connected to the first width-adjustment shaft 32, opposite to the first height-adjustment shaft 34. Furthermore, the second width-adjustment shaft 33 is terminally connected to the first height-adjustment shaft 34. Finally, the second height-adjustment shaft 34 is terminally connected to the second width-adjustment shaft 33, opposite to the first height-adjustment shaft 34. Consequently, the first width-adjustment shaft 32, the second width-adjustment shaft 33, the first height-adjustment shaft 34, and the second height-adjustment shaft 34 forma a frame with dimensions that can be modified by the user. The width-adjustable characteristics of the adjustable ceiling-connection frame 31 enable the adjustable ceiling-connection frame 31 to be mounted onto the adjustable frame formed by the plurality of length-adjustable support beams 1 without impeding the adjustable characteristics of the first width-adjustment beam 4 and the second width-adjustment beam 5. To accomplish this, the first height-adjustment shaft 34 is mounted adjacent to the first height-adjustment beam 6, opposite to the second width-adjustment beam 5. Furthermore, the second height-adjustment shaft 34 is mounted adjacent to the second height-adjustment beam 7, opposite to the second width-adjustment beam 5. Thus positioned, the adjustable ceiling-connection frame 31 is able to extend between the top of the adjustable frame formed by the plurality of length-adjustable support beams 1 and the ceiling of the room in which the present invention is being installed.

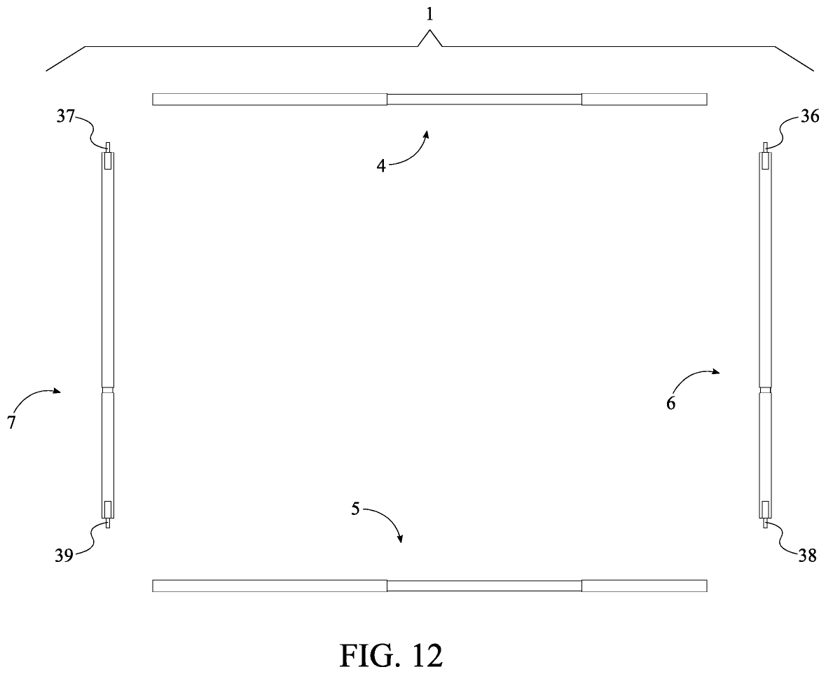

As can be seen in FIG. 1 and FIG. 12, one key functionality of the present invention is the ability to reconfigure each of the components as the user desires. As described above, the user is given the option to modify the physical dimensions of the adjustable frame formed by the plurality of length-adjustable support beams 1 and the adjustable ceiling-connection frame 31. Additionally, the user is able to mount various architectural panel systems into the present invention. To extend this reconfigurable functionality, the present invention comprises a first beam-locking mechanism 36, a second beam-locking mechanism 37, a third beam-locking mechanism 38, and a fourth beam-locking mechanism 39. Each of the beam locking mechanisms is a disengageable fastener that is used to form a connection between two components of the present invention. Specifically, the first beam-locking mechanism 36 is operatively integrated into the terminal connection between the first width-adjustment beam 4 and the first height-adjustment beam 6, wherein the first beam-locking mechanism 36 is used to attach the first width-adjustment beam 4 to the first height-adjustment beam 6. Consequently, the first beam-locking mechanism 36 acts as a fastener that the user can disengage and thus disconnect the first width-adjustment beam 4 from the first height-adjustment beam 6. Similarly, the second beam-locking mechanism 37 is operatively integrated into the terminal connection between the first width-adjustment beam 4 and the second height-adjustment beam 7, wherein the second beam-locking mechanism 37 is used to attach the first width-adjustment beam 4 to the second height-adjustment beam 7. Accordingly, the second beam-locking mechanism 37 acts as a fastener that the user can disengage and thus disconnect the first width-adjustment beam 4 from the second height-adjustment beam 7. Likewise, the third beam-locking mechanism 38 is operatively integrated into the terminal connection between the second width-adjustment beam 5 and the first height-adjustment beam 6, wherein the third beam-locking mechanism 38 is used to attach the second width-adjustment beam 5 to the first height-adjustment beam 6. As a result, the third beam-locking mechanism 38 acts as a fastener that the user can disengage and thus disconnect the second width-adjustment beam 5 from the first height-adjustment beam 6. Finally, the fourth beam-locking mechanism 39 is operatively integrated into the terminal connection between the second width-adjustment beam 5 and the second height-adjustment beam 7, wherein the fourth beam-locking mechanism 39 is used to attach the second width-adjustment beam 5 to the first height-adjustment beam 6. Thus integrated, the fourth beam-locking mechanism 39 acts as a fastener that the user can disengage and thus disconnect the second width-adjustment beam 5 from the first height-adjustment beam 6. The first beam-locking mechanism 36, the second beam-locking mechanism 37, the third beam-locking mechanism 38, and the fourth beam-locking mechanism 39 are preferably barrel locks that the user can unlock to disengage each respective terminal connection. The present invention is designed to use barrel locks to establish connections between each of the various components required to construct the adjustable ceiling-connection system, the panel reel system, and the accordion door assembly. This connection scheme facilitates removal of these components as the user desires.

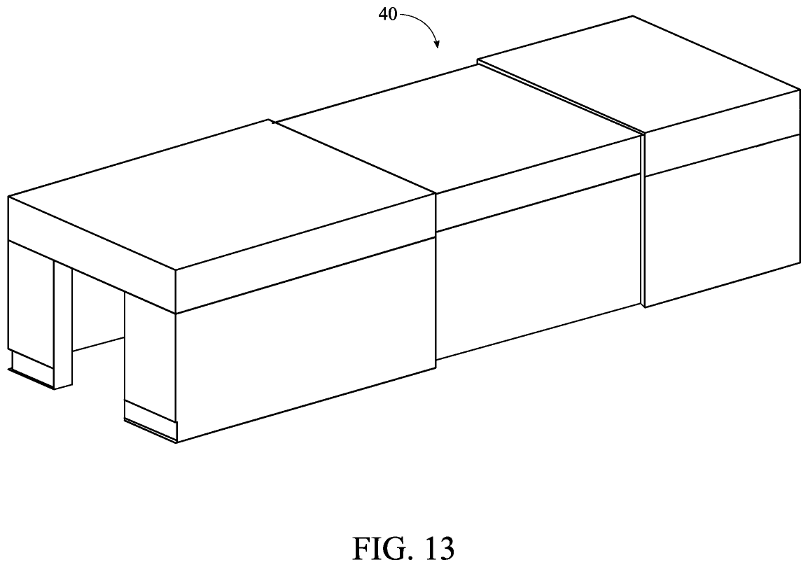

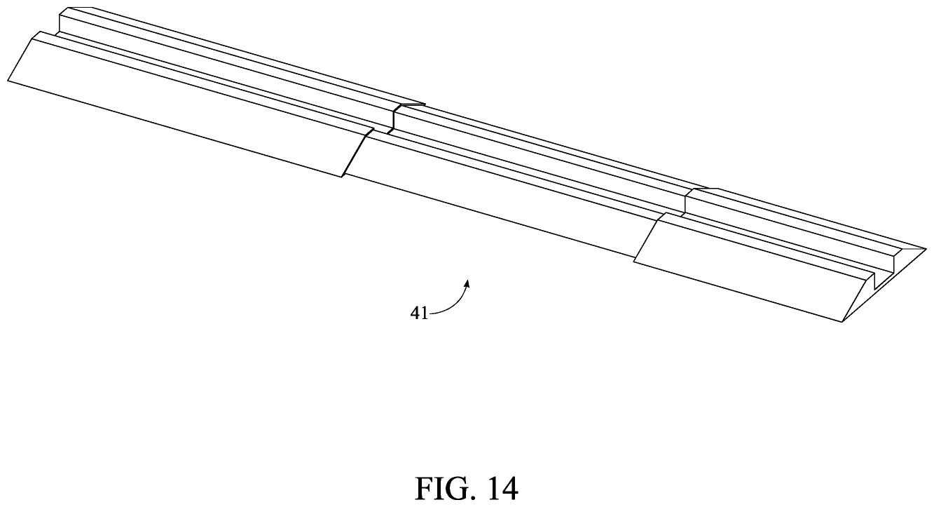

As can be seen in FIG. 1, FIG. 13 and FIG. 14, the present invention further comprises a length-adjustable valance 40 that can be employed when the present invention is deployed as a window frame. As such the length-adjustable valance 40 is mounted adjacent to the first width-adjustment beam 4 so that the length-adjustable valance 40 can be used to add aesthetic appeal to the architectural structure to which the present invention is attached. The present invention further comprises a length-adjustable threshold 41. The length-adjustable threshold 41 is mounted adjacent to the second width-adjustment beam 5. As a result, the present invention can be used to form a doorframe into which a door can be mounted.

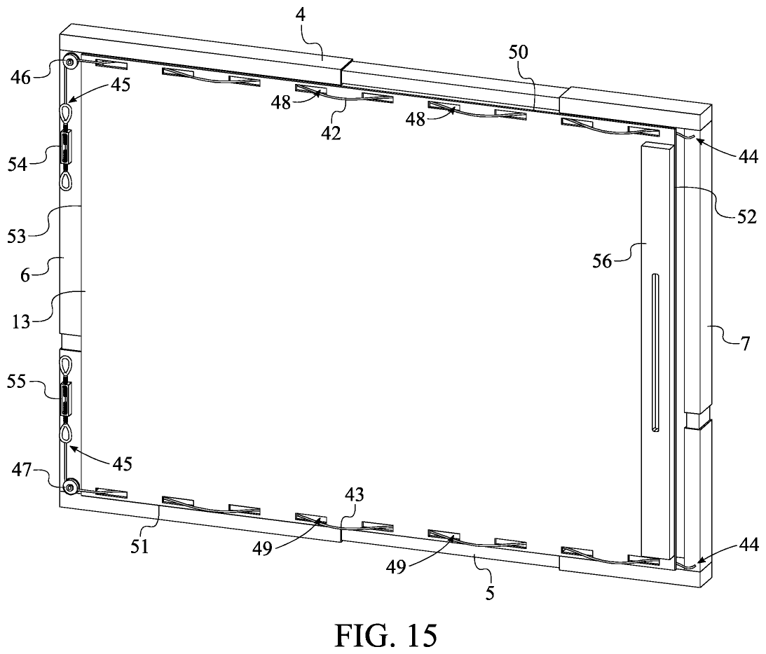

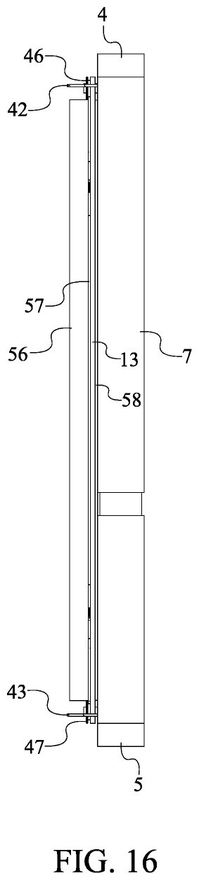

In another embodiment of the present invention and with reference to FIGS. 15 and 16, the first panel-connecting mechanism 10 comprises a first cable 42 and a first pulley 46. The first cable 42 and the first pulley 46 form a pulley system that allows the top of the sheet of panel material 13 to be moved across the frame of the present invention. In addition, the second panel-connecting mechanism 11 comprises a second cable 43 and a second pulley 47. The second cable 43 and the second pulley 47 form a pulley system that allows the bottom of the sheet of panel material 13 to be moved across the frame of the present invention. The first pulley 46 and the second pulley 47 are rotatably and laterally connected to the first height-adjustment beam 6 and are positioned opposite to each other along the first height-adjustment beam 6. This arrangement allows the first pulley 46 and the second pulley 47 to freely rotate in order to transmit a rope of material. The first cable 42 is woven across the sheet of panel material 13 and the second cable 43 is woven across the sheet of panel material 13. Further, the first cable 42 and the second cable 43 is positioned opposite to each other across the sheet of panel material 13. This arrangement allows the sheet of panel material 13 to move along with the first cable 42 and the second cable 43, when the sheet of panel material is pulled to be closed or open. The first cable 42 is tensionably engaged to the first pulley 46, and the second cable 43 is tensionably engaged to the second pulley 47. This arrangement allows the first cable 42 and the second cable 43 to be respectively rolled about through the first pulley 46 and the second pulley 47. Further, the first cable 42 and the second cable 43 are tethered to the first height-adjustment mechanism 10 in order to allow a user to pull the sheet of panel material 13 to be open or closed.

With reference to FIG. 15, the present invention may further comprise a plurality of first eyelets 48 and a plurality of second eyelets 49. The plurality of first eyelets 48 and the plurality of second eyelets 49 are openings that allow the first cable 42 and the second cable 43 to be woven across the sheet of panel material 13. The sheet of panel material 13 comprises a first lengthwise edge 50 and a second lengthwise edge 51. The plurality of first eyelets 48 and the plurality of second eyelets 49 are integrated into the sheet of panel material 13. In further detail, the plurality of first eyelets 48 and the second plurality of eyelets traverse through the sheet of panel material 13 in order to create openings to respectively receive the first cable 42 and the second cable 43. The plurality of first eyelets 48 is evenly distributed along the first lengthwise edge 50, and the first cable 42 traverses into and out of the plurality of first eyelets 48. This arrangement allows the first cable 42 to be evenly woven across the sheet of panel material 13 in order for the sheet of panel material 13 to properly move along with the first cable 42. Further, this arrangement forms pleats along the first lengthwise edge 50 when the sheet of panel material 13 is moved into a closed position. Similarly, the plurality of second eyelets 49 is evenly distributed along the second lengthwise edge 51, and the second cable 43 traverses into and out of the plurality of second eyelets 49. This arrangement allows the second cable 43 to be evenly woven across the sheet of panel material 13 in order for the sheet of panel material 13 to properly move along with the second cable 43. Further, this arrangement forms pleats along the second lengthwise edge 51 when the sheet of panel material 13 is moved into a closed position.

The first panel-connecting mechanism 10 further comprises a first turnbuckle 54. The first turnbuckle 54 is a device to adjust the tension or length of the first cable 42. Similarly, the second panel-connecting mechanism 11 comprises a second turnbuckle 55. The second turnbuckle 55 is a device to adjust the tension or length of the second cable 43. The first cable 42 and the second cable 43 each comprise a distal end 44 and a proximal end 45. The distal end 44 of the first cable 42 and the distal end 44 of the second cable 43 are fixed to the sheet of panel material 13. This arrangement prevents the first cable 42 and the second cable 43 from being removed from the sheet of panel material 13. The proximal end 45 of the first cable 42 is fixed to the first height-adjustment beam 6 by the first turnbuckle 54. This arrangement allows the first cable 42 to be adjusted in tension or length. The proximal end 45 of the second cable 43 is fixed to the first height-adjustment beam 6 by the second turnbuckle 55. This arrangement allows the second cable 43 to be adjusted in tension or length.

With reference to FIGS. 15 and 16, the present invention may further comprise a drawbar 54, a first fastener 57, a second fastener 58. The drawbar 54 is used as a handle to move the sheet of panel material 13 across the frame of the present invention. The first fastener 57 may be any type of fastener used to attach the drawbar 54 onto the sheet of panel material 13. Further, the first fastener 57 is preferably a hook-and-loop fastener. The sheet of panel material 13 comprises a first widthwise edge 52 and a second widthwise edge 53. The drawbar 54 is attached along the first widthwise edge 52 by the first fastener 57. This arrangement allows the user to attach or detach the drawbar 54 onto or from the sheet of panel material 13 when desired. The second widthwise edge 53 is attached along the second height-adjustment beam 7 by the second fastener 58. This arrangement prevents the sheet of panel material 13 from being removed when being pulled to be open or closed.

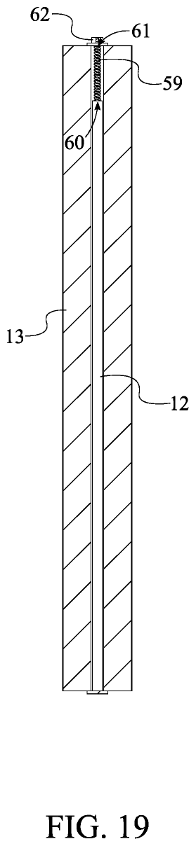

In another embodiment of the present invention and with reference to FIG. 19, the present invention may further comprise a torsion spring 59 and a tension-adjustment mechanism 62. The torsion spring 59 is a torsion device used to supply a torque force after being twisted. The torsion spring 59 comprises a first spring end 60 and a second spring end 61. The panel reel 12 is rotatably mounted to the first height-adjustment beam 6. This arrangement allows the panel reel 12 to freely rotate and therefore allow the sheet of panel material 13 to be wound around the panel reel 12. The first spring end 60 is fixed to the panel reel 12. This arrangement allows the torsion spring 59 to transfer a torque force to the panel reel 12 which rotates the panel reel 12, and thus winds the sheet of panel of material 13 around the panel reel 12. In this embodiment of the present invention, the sheet of panel material 13 is vinyl material. In further detail, the user is able to pull the sheet of panel material 13 from the panel reel 12 in order to close off the area between the first height-adjustment beam 6 and the second height-adjustment beam 7. Moreover, the sheet of panel material 13 will automatically retract and wind around the panel 12 when no pull force is applied. Therefore, the present invention may further comprise a foot stop. The foot stop is laterally connected to the second width-adjustment beam 5. The foot stop is used to maintain the sheet of panel material 13 in a certain position when pulled from the panel reel 12. The second spring end 61 is operatively mounted to the first height-adjustment beam 4 by the tension-adjustment mechanism 62, wherein the tension-adjustment mechanism 62 is used to adjust a spring constant of the torsion spring 59. This arrangement allows the torsion spring 59 to be twisted and thus store mechanical energy. Further, this arrangement allows the user to control the retractability speed of the sheet of panel material 13 by adjusting the spring constant of the torsion spring 59.

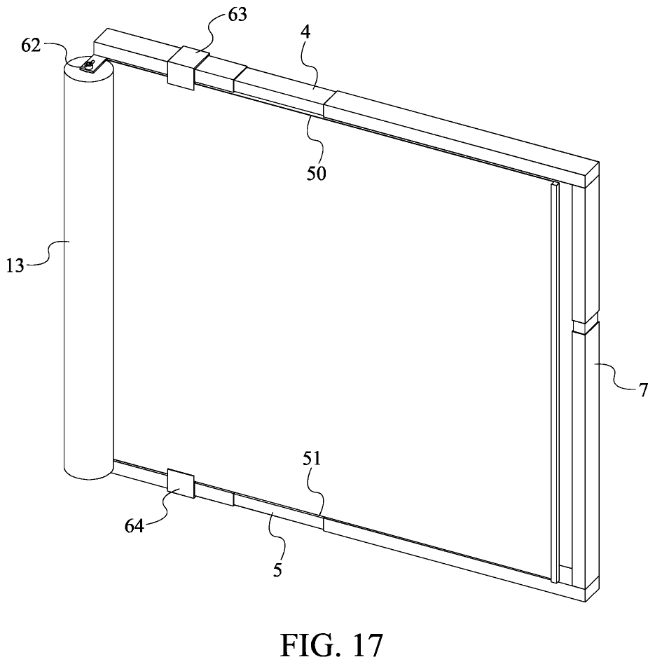

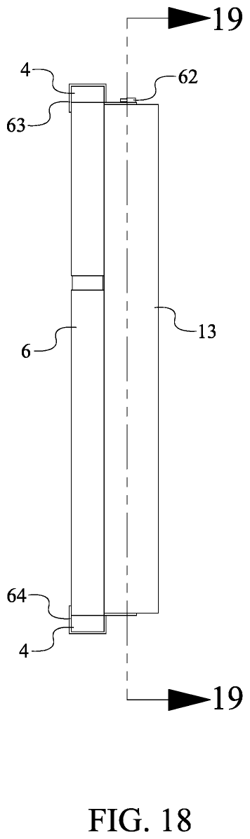

With reference to FIGS. 17 and 18, the present invention may further comprise at least one first guide bracket 63 and at least one second guide bracket 64. The at least one first guide bracket 63 and the at least one second guide bracket 64 are used to guide the sheet of panel material 13 when being retracted into and pulled from the panel reel 12. The at least one first guide bracket 63 is laterally connected to the first width-adjustment beam 4, and the first lengthwise edge 50 is slidably engaged to the at least one first guide bracket 63. In further detail, the present invention may further comprise a first material rail. The first material rail is mounted between the first height-adjustment beam 6 and the second height-adjustment beam 7 and is positioned offset from the first width-adjustment beam 4. The first material rail can be telescopic to fit a myriad of lengths. The first material rail is mounted to the first width-adjustment beam 4 through the at least one first guide bracket 63. This arrangement properly positions the at least one first guide bracket 63 and the first material rail in order to guide the top of the sheet of panel material 13 when being retracted around or pulled from the panel reel 12. In further detail, the at least one first guide bracket 63 comprises a first material slit in order to receive the sheet of panel material 13. Moreover, the at least one first guide bracket 63 allows a bit of flexibility for the first material rail while also supporting the first material rail in order for the first material rail to remain level at all times. The at least one second guide bracket 64 is laterally connected to the second width-adjustment beam 5, and the second lengthwise edge 51 is slidably engaged to the at least one second guide bracket 64. In further detail, the present invention may further comprise a second material rail. The second material rail is mounted between the first height-adjustment beam 6 and the second height-adjustment beam 7 and is positioned offset from the second width-adjustment beam 5. The second material rail can be telescopic to fit a myriad of lengths. The second material rail is mounted to the second width-adjustment beam 5 through the at least one second guide bracket 64. This arrangement properly positions the at least one second guide bracket 64 and the second material rail in order to guide the bottom of the sheet of panel material 13 when being retracted around or pulled from the panel reel 12. In further detail, the at least one second guide bracket 64 comprises a second material slit in order to receive the sheet of panel material 13. Moreover, the at least one second guide bracket 64 allows a bit of flexibility for the second material rail while also supporting the second material rail in order for the second material rail to remain level at all times.

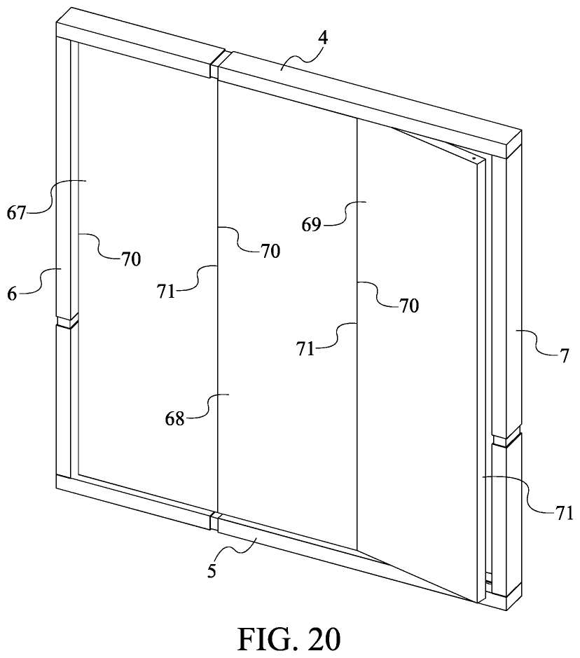

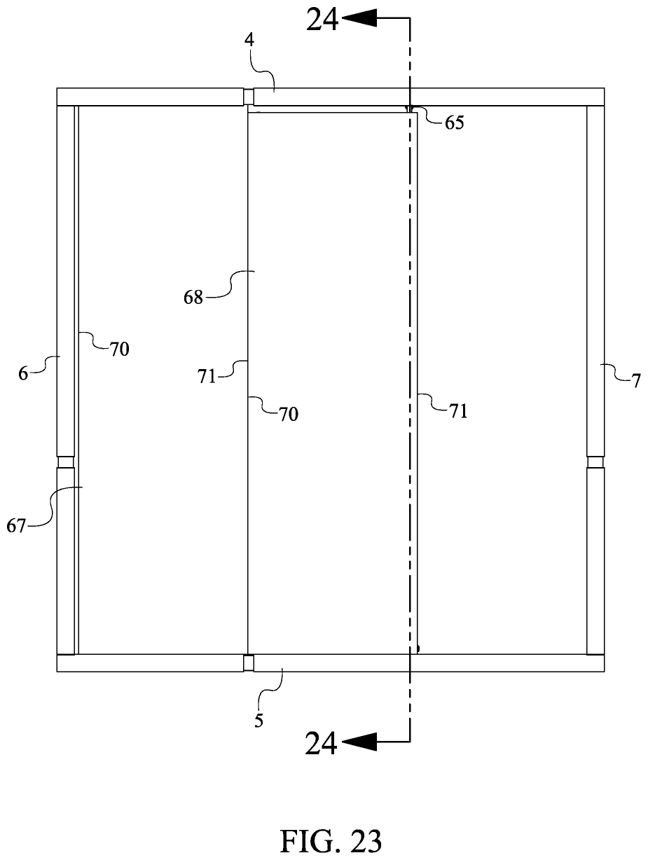

In another embodiment of the present invention and with reference to FIGS. 20 through 23, the present invention may further comprise a roller assembly 65 and a latched slide pin 66. The roller assembly 65 allows a section of the accordion door 18 to be slidably moved in order for part of the accordion door 18 to be open or closed. The latched slide pin 66 is used to secure part of the accordion door 18 to the first width-adjustment beam 4. The accordion door 18 comprises a first door 67, a second door 68, and a third door 69. The first door 67, the second door 68, and third door 69 are sectionalized parts of the accordion door 18. The first door 67, the second door 68, and the third door 69 each comprise a first heightwise edge 70 and a second heightwise edge 71. The first heightwise edge 70 of the first door 67 is hingedly connected in between the first width-adjustment beam 4 and the second width-adjustment beam 5. In further detail, the first heightwise edge 70 of the first door 67 is hingedly connected through latched slide pins which allow the first door 67 to freely rotate about the first height-adjustment beam 6. Further, this arrangement allows the first door 67 allows the user to easily lift-off and remove the first door 67 after the second door 68 and third door 69 are removed. The hinged connection of the first door 67 allows for rotation of the first door 67 and thus allows a user to open or close the first door 67. The first heightwise edge 70 of the first door 67 is positioned adjacent to the second height-adjustment beam 7. This arrangement further allows rotation of the first door 67 about the second height-adjustment beam 7. The second heightwise edge 71 of the first door 67 is hingedly connected to the first heightwise edge 70 of the second door 68. This arrangement allows the first door 67 to be rotated about the first heightwise edge 70 of the second door 68, and the second door 68 to be rotated about the second heightwise edge 71 of the first door 67. The second heightwise edge 71 of the second door 68 is hingedly connected to the first heightwise edge 70 of the third door 69. This arrangement allows the second door 68 to be rotated about the first heightwise edge 70 of the third door 69, and the third door 69 to be rotated about the second heightwise edge 71 of the second door 68. In further detail, the arrangement between the first door 67, the second door 68, and the third door 69 creates an accordion-type mechanism between each door and thus forms the accordion door 18. The third door 69 is primarily the entrance or exit door in this embodiment of the present invention. Therefore, the present invention may further comprise a pull handle. The pull handle is integrated into the third door 69 and positioned adjacent to the second heightwise edge 71 of third door 69. The pull handle allows the user to open or close the third door 69.

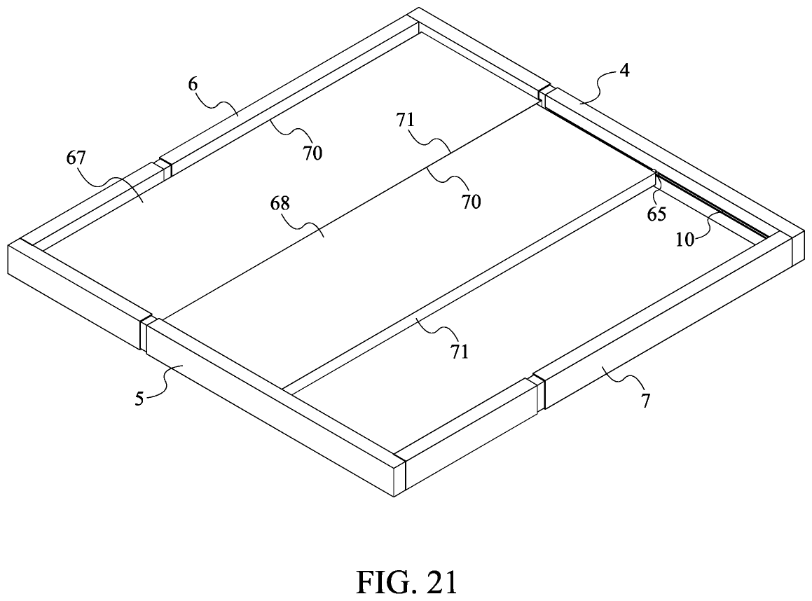

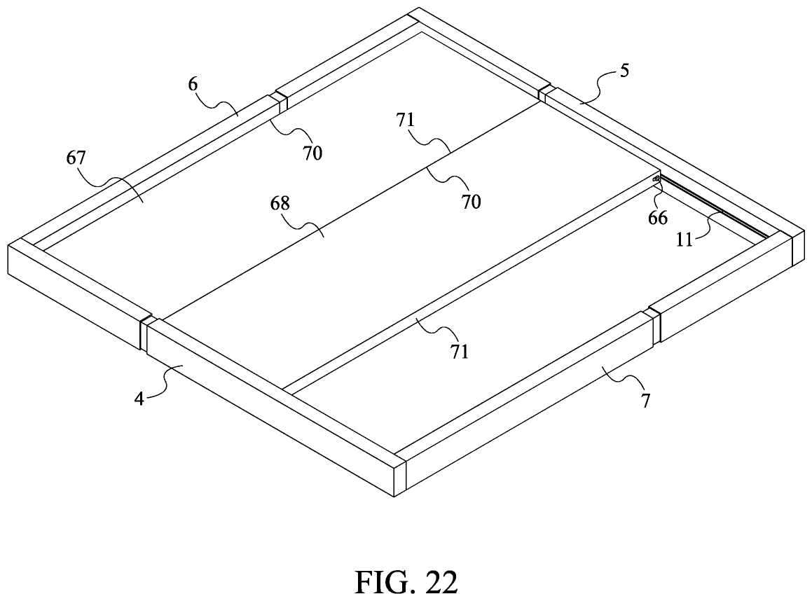

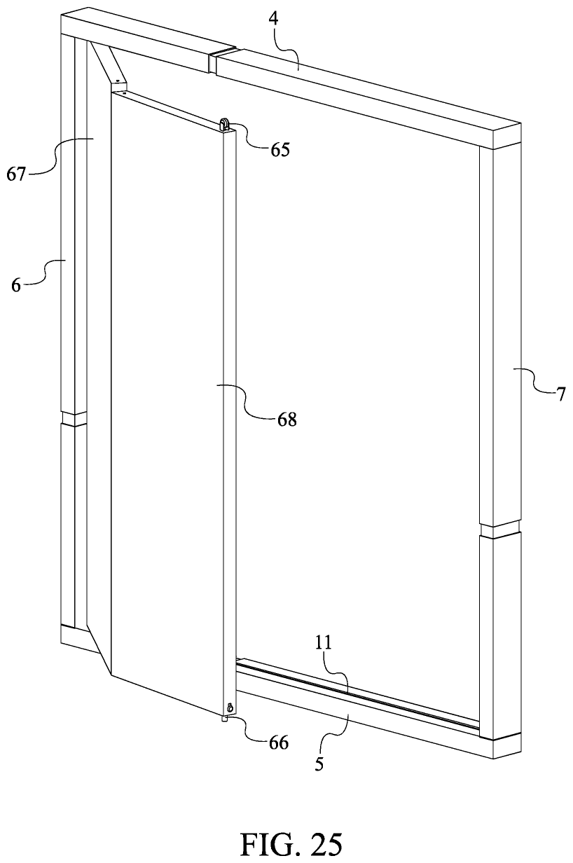

With reference to FIGS. 21, 23, and 25, the roller assembly 65 is laterally mounted to the second door 68, adjacent to the second heightwise edge 71 of the second door 68 and is movably engaged along the first track 10. This arrangement allows the second door 68 to be slidably moved in order the second door 68 to be open or closed. With reference to FIGS. 22 and 25, the latched slide pin 66 is laterally mounted to the second door 68, adjacent to the second heightwise edge 71 of the second door 68 and is positioned opposite to the roller assembly 65 across the second door 68. This arrangement fully secures the second door 68 to the frame of the present invention while allowing the user to remove the second door 68 when desired by remove the latched slide pin 66. Moreover, the latched slide pin 66 is movably engaged along the second track 11. This arrangement further allows the second door 68 to be slidably moved in order for second door 68 to be open or closed. Further and with reference to FIG. 25, the arrangement of the roller assembly 65 and the latched slide pin 67 allows the second heightwise edge 71 of the second door 68 to be respectively lifted off and removed from the first width-adjustment beam 4 and the second width-adjustment beam 5. Moreover, this allows a user to fully remove the second door 68. The third door 69 can be first removed through detachment of the hinged connected between the second door 68 and the third door 69. After the third door 69 is removed, the user can disengage the roller assembly 65 from the first track 10. Then, the user can disengage the latched slide pin 67 from the second track 11. Thus, the second door 68 can be lifted off and removed from the first width-adjustment beam 4 and the second width-adjustment beam 5. After the third door 69 and the second door 68 have been lifted off and removed, the first door 67 can be lifted off and removed by disengaging the hinged connection between the first heightwise edge 70 of the first door 67, the first width-adjustment beam 4 and the second width-adjustment beam 5.

Although the invention has been explained in relation to its preferred embodiment, it is to be understood that many other possible modifications and variations can be made without departing from the spirit and scope of the invention as hereinafter claimed.

What is claimed is:

1. An adjustable architectural frame system comprises:
a plurality of length-adjustable support beams;
a first panel-connecting mechanism;
a second panel-connecting mechanism;
the plurality of length-adjustable support beams comprises a first width-adjustment beam, a second width-adjustment beam, a first height-adjustment beam, and a second height-adjustment beam;
the first height-adjustment beam being terminally connected to the first width-adjustment beam;
the second height-adjustment beam being terminally connected to the first width-adjustment beam, opposite to the first height-adjustment beam;
the second width-adjustment beam being terminally connected to the first height-adjustment beam, opposite to the second height-adjustment beam;
the second height-adjustment beam being terminally connected to the second width-adjustment beam, opposite to the first height-adjustment beam;
the first panel-connecting mechanism being laterally mounted along the first width-adjustment beam; and
the second panel-connecting mechanism being laterally mounted along the second width-adjustment beam.

2. The adjustable architectural frame system as claimed in claim 1 comprises:
each of the plurality of length-adjustable support beams comprises an interior rail and an exterior sleeve; and
the exterior sleeve being telescopically engaged along the interior rail.

3. The adjustable architectural frame system as claimed in claim 2 comprises:
the second height-adjustment beam comprise a handle-receiving slot and a handle;
the handle-receiving slot traversing into the exterior sleeve;
the handle-receiving slot being positioned along the exterior sleeve;
the handle being laterally connected to the interior rail; and
the handle being slidably engaged the handle-receiving slot.

4. The adjustable architectural frame system as claimed in claim 1 comprises:
the first panel-connecting mechanism being a first telescopic guide rail;
the second panel-connecting mechanism being a second telescopic guide rail;
a panel reel;
a sheet of panel material;
a panel extension rod;
the first telescopic guide rail being mounted along the first width-adjustment beam;
the second telescopic guide rail being mounted along the second width-adjustment beam;
the panel reel being mounted along the first height-adjustment beam;
the sheet of panel material being wound about the panel reel;
the panel extension rod being slidably mounted in between the first telescopic guide rod and the second telescopic guide rod; and
the panel extension rod being adjacently connected to the sheet of panel material, opposite to the panel reel.

5. The adjustable architectural frame system as claimed in claim 4 comprises:
a first rod carriage;
a second rod carriage;
a carriage-actuation mechanism;
the first rod carriage being terminally connected to the panel extension rod;
the first rod carriage being slidably engaged along the first telescopic guide rod;
the second rod carriage being terminally connected to the panel extension rod, opposite to the first rod carriage;
the second rod carriage being slidably engaged along the second telescopic guide rod; and
the carriage-actuation mechanism being operatively integrated in between the first rod carriage and the first height-adjustment beam, wherein the carriage-actuation mechanism is used to slide the first rod carriage along the first telescoping guide rail.

6. The adjustable architectural frame system as claimed in claim 1 comprises:
the first panel-connecting mechanism being a first track;
the second panel-connecting mechanism being a second track;
an accordion door;
the first track being connected along the first width-adjustment beam;
the second track being connected along the second width-adjustment beam;
a first side of the accordion door being mounted adjacent to the first height-adjustment beam; and
the accordion door being slidably mounted in between the first track and the second track.

7. The adjustable architectural frame system as claimed in claim 6 comprises:
the accordion door comprises an openable panel, an entryway hole, and a nested door;
the entryway hole traversing through the openable panel; and
the nested door being hingedly connected to the openable panel across the entryway hole.

8. The adjustable architectural frame system as claimed in claim 7 comprises:
a bar-receiving receptacle;
a length-adjustable security bar;
the bar-receiving receptacle being adjacently connected to the second height-adjustment beam;
a first end of the length-adjustable security bar being adjacently and pivotably connected to the first height-adjustment beam;
a second end of the length-adjustable security bar engaging into the bar-receiving receptacle; and
the length adjustable security bar being positioned across the accordion door.

9. The adjustable architectural frame system as claimed in claim 1 comprises:
a first angle-adjustment joint;
a second angle-adjustment joint;
the first angle-adjustment joint being integrated into the terminal connection between the first height-adjustment beam and the first width-adjustment beam; and
the second angle-adjustment joint being integrated into the terminal connection between the second height-adjustment beam and the first width-adjustment beam.

10. The adjustable architectural frame system as claimed in claim 9 comprises:
the first angle-adjustment joint comprises a first semicircular groove and a first connector peg;
the first semicircular groove traversing into the first height-adjustment beam;
the first connector peg being laterally connected to the first width-adjustment beam; and
the first connector peg being engaged along the first semicircular groove.

11. The adjustable architectural frame system as claimed in claim 9 comprises:
the second angle-adjustment joint comprises a second semicircular groove and a second connector peg;
the second semicircular groove traversing into the second height-adjustment beam;
the second connector peg being laterally connected to the first width-adjustment beam; and
the second connector peg being engaged along the second semicircular groove.

12. The adjustable architectural frame system as claimed in claim 9 comprises:
a plurality of roller wheels;
each of the plurality of roller wheels being laterally mounted onto the first width-adjustment beam; and
the plurality of roller wheels being distributed along the first width-adjustment beam.

13. The adjustable architectural frame system as claimed in claim 1 comprises:
an adjustable ceiling-connection frame; and
the adjustable ceiling-connection frame being mounted onto the first height-adjustment beam and the second height adjustment beam.

14. The adjustable architectural frame system as claimed in claim 13 comprises:
the adjustable ceiling-connection frame comprises a first width-adjustment shaft, a second width-adjustment shaft, a first height-adjustment shaft, and a second height-adjustment shaft;
the first height-adjustment shaft being terminally connected to the first width-adjustment shaft;
the second height-adjustment shaft being terminally connected to the first width-adjustment shaft, opposite to the first height-adjustment shaft;
the second width-adjustment shaft being terminally connected to the first height-adjustment shaft;
the second height-adjustment shaft being terminally connected to the second width-adjustment shaft, opposite to the first height-adjustment shaft;
the first height-adjustment shaft being mounted adjacent to the first height-adjustment beam, opposite to the second width-adjustment beam; and
the second height-adjustment shaft being mounted adjacent to the second height-adjustment beam, opposite to the second width-adjustment beam.

15. The adjustable architectural frame system as claimed in claim 1 comprises:
a first beam-locking mechanism; and
the first beam-locking mechanisms being operatively integrated into the terminal connection between the first width-adjustment beam and the first height-adjustment beam, wherein the first beam-locking mechanism is used to attach the first width-adjustment beam to the first height-adjustment beam.

16. The adjustable architectural frame system as claimed in claim 1 comprises:
a second beam-locking mechanism; and
the second beam-locking mechanisms being operatively integrated into the terminal connection between the first width-adjustment beam and the second height-adjustment beam, wherein the second beam-locking mechanism is used to attach the first width-adjustment beam to the second height-adjustment beam.

17. The adjustable architectural frame system as claimed in claim 1 comprises:
a third beam-locking mechanism; and
the third beam-locking mechanisms being operatively integrated into the terminal connection between the second width-adjustment beam and the first height-adjustment beam, wherein the third beam-locking mechanism is used to attach the second width-adjustment beam to the first height-adjustment beam.

18. The adjustable architectural frame system as claimed in claim 1 comprises:
a fourth beam-locking mechanism; and
the fourth beam-locking mechanisms being operatively integrated into the terminal connection between the second width-adjustment beam and the second height-adjustment beam, wherein the fourth beam-locking mechanism is used to attach the second width-adjustment beam to the first height-adjustment beam.

19. The adjustable architectural frame system as claimed in claim 1 comprises:
a length-adjustable valance; and
the length-adjustable valence being mounted adjacent to the first width-adjustment beam.

20. The adjustable architectural frame system as claimed in claim 1 comprises:
a length-adjustable threshold; and
the length-adjustable threshold being mounted adjacent to the second width-adjustment beam.

21. The adjustable architectural frame system as claimed in claim 1 comprises:
the first panel-connecting mechanism comprises a first cable and a first pulley;
the second panel-connecting mechanism comprises a second cable and a second pulley;
a sheet of panel material;
the first pulley and the second pulley being rotatably and laterally connected to the first height-adjustment beam;
the first pulley and the second pulley being positioned opposite to each other along the first height-adjustment beam;
the first cable being woven across the sheet of panel material;
the second cable being woven across the sheet of panel material;
the first cable and the second cable being positioned opposite to each other across the sheet of panel material;
the first cable being tensionably engaged to the first pulley;
the second cable being tensionably engaged to the second pulley; and
the first cable and the second cable being tethered to the first height-adjustment mechanism.

22. The adjustable architectural frame system as claimed in claim 21 comprises:
a plurality of first eyelets;
a plurality of second eyelets;
the sheet of panel material comprises a first lengthwise edge and a second lengthwise edge;
the plurality of first eyelets and the plurality of second eyelets being integrated into the sheet of panel material;
the plurality of first eyelets being evenly distributed along the first lengthwise edge;
the first cable traversing into and out of the plurality of first eyelets;
the plurality of second eyelets being evenly distributed along the second lengthwise edge; and
the second cable traversing into and out of the plurality of second eyelets.

23. The adjustable architectural frame system as claimed in claim 21 comprises:
the first panel-connecting mechanism further comprises a first turnbuckle;
the second panel-connecting mechanism comprises a second turnbuckle;
the first cable and the second cable each comprises a distal end and a proximal end;
the distal end of the first cable and the distal end of the second cable being fixed to the sheet of panel material;
the proximal end of the first cable being fixed to the first height-adjustment beam by the first turnbuckle; and
the proximal end of the second cable being fixed to the first height-adjustment beam by the second turnbuckle.

24. The adjustable architectural frame system as claimed in claim 21 comprises:
a drawbar;
a first fastener;
a second fastener;
the sheet of panel material comprises a first widthwise edge and a second widthwise edge;
the drawbar being attached along the first widthwise edge by the first fastener; and
the second widthwise edge being attached along the second height-adjustment beam by the second fastener.

25. The adjustable architectural frame system as claimed in claim 4 comprises:
a torsion spring;
a tension-adjustment mechanism;
the torsion spring comprises a first spring end and a second spring end;
the panel reel being rotatably mounted to the first height-adjustment beam;
the first spring end being fixed to the panel reel; and
the second spring end being operatively mounted to the first height-adjustment beam by the tension-adjustment mechanism, wherein the tension-adjustment mechanism is used to adjust a spring constant of the torsion spring.

26. The adjustable architectural frame system as claimed in claim 4 comprises:
at least one first guide bracket;
at least one second guide bracket;
the sheet of panel material comprises a first lengthwise edge and a second lengthwise edge;
the at least one first guide bracket being laterally connected to the first width-adjustment beam;
the first lengthwise edge being slidably engaged to the first guide bracket;
the at least one second guide bracket being laterally connected to the second width-adjustment beam; and
the second lengthwise edge being slidably engaged to the second guide bracket.

27. The adjustable architectural frame system as claimed in claim 6 comprises:
a roller assembly;
a latched slide pin;
the accordion door comprises a first door, a second door, and a third door;
the first door, the second door, and the third door each comprise a first heightwise edge and a second heightwise edge;
the first heightwise edge of the first door being hingedly connected in between the first width-adjustment beam and the second width adjustment beam;
the first heightwise edge of the first door being positioned adjacent to the second height-adjustment beam;
the second heightwise edge of the first door being hingedly connected to the first heightwise edge of the second door;
the second heightwise edge of the second door being hingedly connected to the first heightwise edge of the third door;
the roller assembly being laterally mounted to the second door, adjacent to the second heightwise edge of the second door;
the roller assembly being movably engaged along the first track;
the latched slide pin being laterally mounted to the second door, adjacent to the second heightwise edge of the second door;
the latched slide pin being positioned opposite to the roller assembly across the second door; and
the latched slide pin being movably engaged along the second track.
